(19) United States
(12) Patent Application Publication
(10) Pub. No.: US 2017/0273396 A1
(43) Pub. Date: Sep. 28, 2017

(54) FOOT SOLE STIMULATION TOOL

(71) Applicant: Norie EGUCHI, Tokyo (JP)

(72) Inventor: Norie EGUCHI, Tokyo (JP)

(21) Appl. No.: 15/081,952

(22) Filed: Mar. 28, 2016

(51) Int. Cl. A43B 7/14; A61H 1/00

(52) U.S. Cl. CPC A43B 7/146; A61H 1/008; A61H 2201/1269

(57) ABSTRACT

A foot sole stimulation tool is provided to press pressure points or support an arch by using protrusions, and the foot sole stimulation tool can place the protrusions in accurate positions. Four or more projections are sealed tightly within a bag body whose bottom side is affixed to a shoe sole, three or more of the projections determine a position of each projection by projections for recessed portion placed on a recessed portion of a foot sole, and projections for convex portion placed on a pressed target part of the foot sole are arranged accurately. The projections for convex portion press the pressure points and support the arch. For example, it can execute pressures to an adductor hallucis muscle precisely and is helpful for preventing hallux valgus.

The contents of the following Japanese patent are incorporated herein by reference:

No. JP 5725634 B1 registered on Apr. 10, 2015.

### BACKGROUND

1. Technical Field

The present invention relates to a foot sole stimulation tool that presses a foot sole through protrusions.

2. Related Art

A tool (which has protrusions to press a foot sole in many cases) on which a foot is placed to stimulate pressure points has been well known since there are many pressure points on the foot sole and a physical condition improving effect can be obtained by stimulating these pressure points. Specifically, as disclosed in Patent Document 1, there have been many tools to stimulate foot soles by shoe insoles.

Also, as disclosed in Patent Document 2, having protrusions in shoe insoles and the like could also support arches that foot bones form.

When stimulations to pressure points are performed by providing protrusions in shoe insoles and the like, it is not easy to adjust positions of the protrusions. Since positions of each part of a foot differ from individual to individual, it is preferable to adjust the positions of the protrusions to conform with each user.

On this point, a foot sole stimulation tool which can move a position of a pressing component has been disclosed in Patent Document 3. Further, a foot sole stimulation tool where a plurality of magnetic poles are provided around accurate stimulation positions has been disclosed in Patent Document 4. Nevertheless, the tool disclosed in Patent Document 3 requires a position adjustment on the user's own, and the tool disclosed in Patent Document 4 is not possible to be applied to pressure protrusions.

### PRIOR ART DOCUMENTS

### Patent Documents

Patent Document 1: Japanese Patent Application Publication No. 2007-061235

Patent Document 2: Japanese Patent Application Publication No. 2012-245029

Patent Document 3: Japanese Patent Application Publication No. 2013-048874

Patent Document 4: Japanese Patent Application Publication No. 2008-173309

### SUMMARY

The present invention may provide a foot sole stimulation tool which presses pressure points or supports arches by using protrusions, the foot sole stimulation tool being able to place the protrusions in accurate positions.

In many cases, the positions of the pressure points are known as positions relative to other points of the foot sole. For example, there is a “middle point” between two fixed positions. Although it is difficult to determine positions of the pressure points with respect to an entire foot sole, it is easy to determine relative positions of the pressure points with respect to such fixed positions. In the present invention, positions of projections which stimulate a foot sole are determined based on the above fact.

A foot sole stimulation tool according to an embodiment of the present invention is a foot sole stimulation tool configured to be affixed to a shoe sole and to stimulate the foot sole, comprising a bag body whose bottom side is affixed to the shoe sole and four or more projections sealed in the bag body tightly, wherein three or more of the four or more projections are projections for recessed portion to be placed on a recessed portion of the foot sole, and one or more of the four or more projections is(are) projection(s) for convex portion to be placed on a pressed target part of the foot sole, and wherein a position of the projections for convex portion is a predetermined stimulation position with respect to positions of other projections determined by fixing the projections for recessed portion on the shoe sole in predetermined fixed positions.

When placing the foot sole stimulation tool on a foot sole, the projections for recessed portion are led to the recessed portion of the foot sole and are arranged accurately. The projections for convex portion press the foot sole (or support the arch). When the pressed target part is a convex portion of a foot sole such as a position of a muscle and the like, it has been difficult to arrange the projections for convex portion accurately. The foot sole stimulation tool according to an embodiment of the present invention has the projections all sealed tightly in the bag body, and therefore, the position of the projection for recessed portion relative to the projections for recessed portion is stable. For example, with respect to a triangle (a triangle which differs slightly depending on the user since it is determined by the position of the recessed portion of the foot sole) determined by three projections for recessed portion, the position of the projection for convex portion (the coordinate relative to the apexes of the triangle) is stable. The projection for convex portion can be arranged accurately. Further, three or more of the projections for recessed portion are necessary so as to set a reference point of a coordinate on the plane of the foot sole (a two-dimensional space).

According to the foot sole stimulation tool according to an embodiment of the present invention, the height of the projections for convex portion with respect to the bottom side is greater than a height of the projections for recessed portion with respect to the bottom side.

The projections for convex portion have the height sufficient to press the pressure points or to support the arch.

In the foot sole stimulation tool of the present invention, the bag body is filled with a liquid.

When the projections move within the bag body, the surface shape of the bag body does not change extremely any more to protect the bag body.

According to the foot sole stimulation tool according to an embodiment of the present invention, the fixed positions are: (1) between a first proximal phalange and a second proximal phalange, (2) between a third proximal phalange and a fourth proximal phalange or between the fourth proximal phalange and a fifth proximal phalange, and (3) a foot arch part of an outer side of a first metatarsal bone; and the stimulation position(s) is(are): (1) a center by a second toe, of a flexor hallucis brevis muscle, (2) a spot by the second toe, of an adductor hallucis muscle connected to the second toe, and (3) a spot by an ankle, of an adductor hallucis muscle connected to a third toe.

As shown in examples described below, the foot sole stimulation tool according to an embodiment of the present invention is in a form having a significant effect.

The foot sole stimulation tool according to an embodiment of the present invention can press the pressure points or support the arch by using the protrusions, and can place the protrusions in accurate positions.

### BRIEF DESCRIPTION OF THE DRAWINGS

FIG. 1 shows a foot sole stimulation tool (Example 1), according to an embodiment of the present invention.

FIG. 2 shows a cross section drawing of the foot sole stimulation tool (Example 1), according to an embodiment of the present invention.

FIG. 3 shows a positional relationship between the foot sole stimulation tool and bones (Example 2), according to an embodiment of the present invention.

FIG. 4 shows a positional relationship between the foot sole stimulation tool and muscles (Example 2), according to an embodiment of the present invention.

FIG. 5 shows a relationship between the foot sole stimulation tool and an arch (Example 2), according to an embodiment of the present invention.

### DESCRIPTION OF EXEMPLARY EMBODIMENTS

The following describes Example 1 showing a configuration of the foot sole stimulation tool according to an embodiment of the present invention and Example 2 showing specific usages and effects of the foot sole stimulation tool according to an embodiment of the present invention.

### Example 1

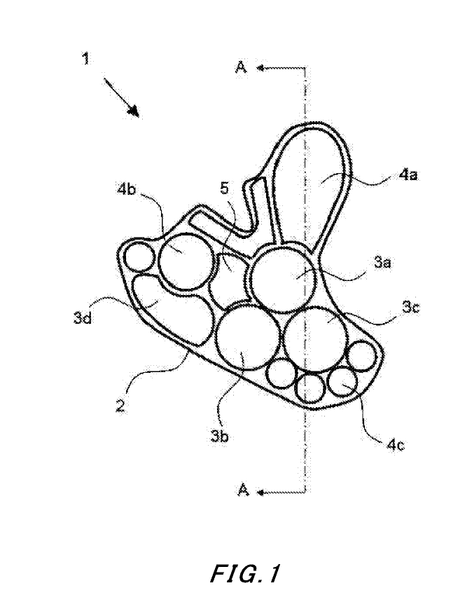

FIG. 1 is a drawing showing a foot sole stimulation tool according to an embodiment of the present invention. The drawing shows a foot sole stimulation tool 1 for right foot viewed from a foot sole side. The foot sole stimulation tool 1 comprises many (at least four) projections sealed tightly within a bag body 2.

The projections include projections for convex portion 3 (3a, 3b, 3c, and 3d), projections for recessed portion 4 (4a, 4b, and 4c) and other projections 5. Further, the other projections 5 are not always necessary; it is also possible to arrange the projections for convex portion 3 and the projections for recessed portion 4 only.

Although the projections can move within the bag body, since many projections are sealed tightly, the movement is limited by the adjacent projections; i.e., one projection is not able to move over another projection, and it is unchanged that each of the projections contacts which of the other projections (the relative position of the projections). The term “tightly” indicates a state where the projections are sealed at a density that the relative position of the projections is substantially unchanged. FIG. 1 shows that the projections are sealed tightly, no movement of the projections being able to broaden an interval between two projections more than a minor axis of the adjacent projection (i.e., the adjacent projection cannot move between two projections).

When a foot is placed on the foot sole stimulation tool 1, the projections for recessed portion 4 are disposed on a recessed portion of the foot sole without any movement. As the foot is put on the foot sole stimulation tool 1, positions of three projections for recessed portion 4a, 4b and 4c are fixed. On a two-dimensional plane of the foot sole, since three points are fixed, the position of the foot sole stimulation tool 1 is also fixed (and the position with respect to the foot sole is also fixed).

The following describes positions of projections other than the projections for recessed portion 4.

When the three projections for recessed portion 4 are fixed (an actual structure of the foot sole matches the structure of the foot sole stimulation tool 1) as shown in the drawing, other projections are also fixed in the positions shown in the drawing, although there is a deviation of slight interval parts between the projections.

When the actual structure of the foot sole does not match the structure of the foot sole stimulation tool 1 and the three projections for recessed portion 4 are fixed in positions different from the ones shown in the drawing, corresponding to a scaling with respect to the drawing of the interval of two of the three projections for recessed portion 4, it gets into a state where the drawing gets scaled on a line connecting the two projections for recessed portion 4. As for the whole foot sole stimulation tool 1, although there is a deviation on a basis of slight intervals among the projections, it gets into a state as performing a linear transformation such as moving the portion of the three projections for recessed portion 4 with respect to the drawing. (This is equivalent to the following one: regarding one of the three projections for recessed portion 4 as an origin and to apply a linear transformation matrix such as moving a coordinate on the plane corresponding to the foot sole of the other two projections for recessed portion 4 to a fixed coordinate.)

The case that the number of the projections for recessed portion 4 is three has been described as above. In a case that the number of the projections for recessed portion 4 is four or more, it can be considered in the same manner by dividing them into triangles configured by three of the projections for recessed portion 4. Although it is not rigorous mechanically, it is close to the actual situation merely with a small difference therebetween according to the above consideration.

As described above, the positions of the projections other than the projections for recessed portion 4 become the predetermined positions, and the projections for convex portion 3 are placed in positions designed for pressing the pressure points, etc.

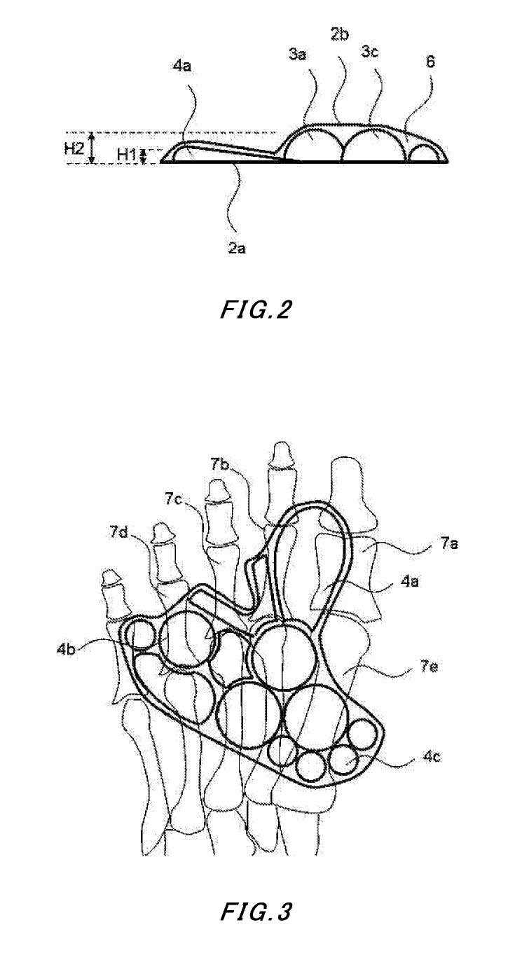

FIG. 2 is a cross section drawing of the foot sole stimulation tool according to an embodiment of the present invention. It shows a cross section of FIG. 1 taken along line A-A. The bag body 2 includes a bottom side part 2a and a surface part 2b, the bottom side part 2a affixed to a shoe sole, a shoe insole and the like. The bottom side part 2a can be affixed to a shoe sole, a shoe insole and the like by adhering the bottom side part 2a to the shoe sole, the shoe insole and the like, by peeling a sheet which is covering an adhesive applied on the bottom side part 2a, or by other type of methods.

In addition to the projections, gel 6 is sealed within the bag body 2. The gel 6 diminishes the shape change of the surface of the bag body 2 small when the projections move. Also, the same effect can be obtained through other liquids other than the gel.

The height H2 of the projections for convex portion 3 is greater than the height H1 of the projections for recessed portion 4. The projections for convex portion 3 press the pressure points and the like by sufficient strength.

As described above in detail, according to the foot sole stimulation tool 1 of the present example, the projections for convex portion 3 are placed in positions designed for pressing the pressure points and the like due to the positions being fixed at the projections for recessed portion 4. Even if there is a little difference in structures of foot soles according to the users, the projections for convex portion 3 exhibit effects.

### Example 2

The present example shows specific usages and effects of the foot sole stimulation tool 1. Since the structure of the foot sole stimulation tool 1 is substantially similar to the one of the Example 1, the detailed description is omitted here.

FIG. 3 is a drawing showing a positional relationship between the foot sole stimulation tool and bones, according to an embodiment of the present invention. The foot sole stimulation tool 1 can be attached to a position that is matched with a drawing showing a front part of the shoe sole. FIG. 3 shows the positions of the foot sole stimulation tool and the bones in this case. The projection for recessed portion 4a is placed between the first proximal phalange 7a and the second proximal phalange 7b, the projection for recessed portion 4b is placed between the third proximal phalange 7c and the fourth proximal phalange 7d, and the projection for recessed portion 4c is placed on the exterior foot arch part of the first metatarsal bone 7e. The three projections for recessed portion 4a, 4b and 4c are fixed between the bones. Accordingly, the position with respect to the foot sole of the foot sole stimulation tool 1 is fixed.

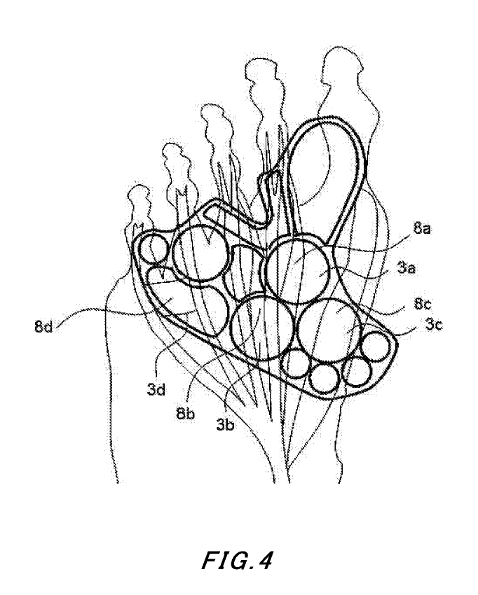

FIG. 4 shows a positional relationship between the foot sole stimulation tool and muscles, according to an embodiment of the present invention. It shows a case of a state shown in FIG. 3 where the foot sole stimulation tool is fixed. The projection for convex portion 3a is placed on a spot by the second toe, of an adductor hallucis muscle 8a connected to the second toe, the projection for convex portion 3b is placed on a spot by an ankle, of an adductor hallucis muscle 8b connected to the third toe, the projection for convex portion 3c is placed on a center by the second toe, of a flexor hallucis brevis muscle 8c, and the projection for convex portion 3d is placed on a spot of an interossei plantares muscle 8d. As shown in FIG. 2, the projections for convex portion 3 have a sufficient height to press the spots.

The projection for convex portion 3a and the projection for convex portion 3b press the adductor hallucis muscles 8a and 8b that result in a comfortable pressing effect.

The projection for convex portion 3c presses the flexor hallucis brevis muscle 8c, due to which a first toe is pressed outwards. Also, the projection for convex portion 3d presses the interossei plantares muscle 8d, due to which a fifth toe is pressed outwards. By combining these effects, a comfortable effect of spreading the toes can be obtained.

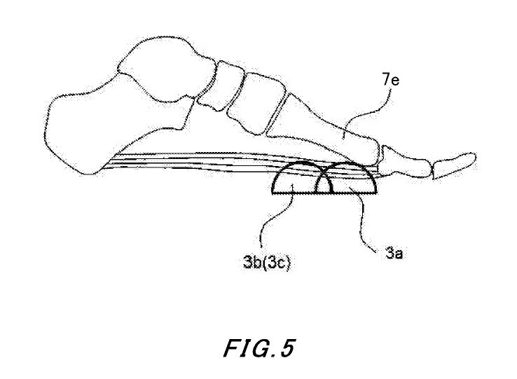

FIG. 5 shows a relationship between the foot sole stimulation tool and the arch, according to an embodiment of the present invention. The arch of the foot sole has an effect such as supporting the weight when walking. The projections for convex portion 3a, 3b and 3c hold up the metatarsal bone 7e from below and support the arch as shown in the drawing.

As described above in detail, the foot sole stimulation tool 1 of the present example exhibits effects by pressing, and supports the arch.

The foot sole stimulation tool presses the pressure points or supports the arch by using the protrusions, and can place the protrusions in accurate positions. Usages by many individuals and medical workers are expected.

What is claimed is:

1. An apparatus comprising:
a bag body having a first side affixed to a shoe sole; and
at least four projections sealed tightly within the bag body, wherein
at least three of the projections are positioned for recessed portions of a foot sole, and
at least one of the projections is positioned for a pressed target part of the foot sole;
wherein a position of the projection positioned for a pressed target part relates to at least one predetermined stimulation position with respect to positions of the projections positioned for recessed portions, which are determined by fixing the projections positioned for recessed portions on the shoe sole in predetermined fixed positions.

2. The apparatus according to claim 1, wherein a height of the projection positioned for a pressed target part with respect to the first side is greater than the height of the projections positioned for recessed portions with respect to the first side.

3. The apparatus according to claim 1, wherein the bag body is filled with a liquid.

4. The apparatus according to claim 1, wherein
the predetermined fixed positions correspond to:
a first recessed portion of the foot sole between a first proximal phalange and a second proximal phalange;
a second recessed portion of the foot sole between a third proximal phalange and a fourth proximal phalange or between the fourth proximal phalange and a fifth proximal phalange; and
a third recessed portion of the foot sole an exterior foot arch part of a first metatarsal bone, and
the at least one predetermined stimulation position corresponds to at least one of:
a pressed target part of the foot sole at a center of a flexor hallucis brevis muscle, by a second toe,
a pressed target part of the foot sole at a spot of an adductor hallucis muscle connected to the second toe, by the second toe, and
a pressed target part of the foot sole at a spot of the adductor hallucis muscle connected to a third toe, by an ankle.
